(19) United States
(12) Patent Application Publication
(10) Pub. No.: US 2008/0180395 A1
(43) Pub. Date: Jul. 31, 2008

(54) Computer pointing input device

(76) Inventor: Robert H. Gray, McDonough, GA (US)

Correspondence Address: LITMAN LAW OFFICES, LTD., P.O. BOX 15035, CRYSTAL CITY STATION, ARLINGTON, VA, 22215, US

(21) Appl. No.: 12/076,847

(22) Filed: Mar. 24, 2008

Related U.S. Application Data
(63) Continuation-in-part of application No. 11/071,467, filed on Mar. 4, 2005.

(51) Int. Cl. G06F 3/033

(52) U.S. Cl. 345/157

(57) ABSTRACT

The computer pointing input device allows a user to determine the position of a cursor on a computer display. The position of the input device in relation to the display controls the position of the cursor, so that when a user points directly at the display, the cursor appears at the intersection of the display and the line of sight from of the input device. When the device is moved, the cursor appears to move on the display in exact relation to the input device. In addition, a cursor command unit allows the user to virtually operate the input device wherein changes in the position of the device allow the user to spatially invoke mouse functions. The computer pointing input device is designed to operate with a computer having a processor through a computer communication device.

### CROSS-REFERENCE TO RELATED APPLICATIONS

This application is a continuation-in-part of U.S. patent application Ser. No. 11/071,467, filed Mar. 4, 2005.

### BACKGROUND OF THE INVENTION

1. Field of the Invention

The present invention relates to a computer peripheral device, and particularly to a computer pointing input device that maintains the cursor on the display with the line of sight of the input device.

2. Description of the Related Art

Numerous computer input devices exist that allow a user to control the movement of a cursor image on a computer display. The conventional input devices use a mechanical device connected to the housing, such as a roller ball, which, when moved about a mouse pad, determines the direction in which the cursor image is to move. Additionally, typical input devices have user-activating buttons to perform specific cursor functions, such as a “double click.”

The conventional input devices have given way, in recent years, to optical technology. The newer devices obtain a series of images of a surface that are compared to each other to determine the direction in which the input device has been moved. However, both types of input devices require that the user be tied to the desktop, as a mouse pad is still necessary.

Although some input devices do exist that are not tied to a desktop, the devices do not allow for a cursor image to almost instantaneously follow along the line of sight of the device. Causing the cursor image to be positioned at the intersection of the line of sight of the input device and the display allows a user to more accurately control the direction the cursor image is to move, as the user is able to ascertain quickly where the cursor image is and where the user would like the cursor image to go.

Although optical methods are known, such as “light guns” or “marker placement” systems, such systems are typically limited to use with cathode ray tube monitors only, and may not be easily adapted to other display systems, such as liquid crystal displays (LCDs). Such systems typically utilize a plurality of optical “markers” positioned about the display, and use a handheld sensor for receiving the marker input. The location of the sensor is triangulated from the position and angle from the set markers. Such systems limit the range of movement of the user's hand and require the camera or other sensor to be built into the handheld device, which may be bulky and not ergonomic. Such systems also do not use a true line-of-sight imaging method, which reduces accuracy.

Further, computer input devices generally use a user-controlled wheel or a set of buttons to invoke mouse functions. After repeated use, however, these buttons or wheels often tend to stick, causing problems for the user. Additionally, use of the buttons and wheels may not be the most efficient or ergonomic method of invoking mouse functions.

Accordingly, there is a need for a computer pointing input device that aligns a cursor image directly with the line of sight of the device and also allows for a user to spatially invoke mouse functions. Thus, a computer pointing input device solving the aforementioned problems is desired.

### SUMMARY OF THE INVENTION

The computer pointing input device allows a user to determine the position of a cursor on a computer display. The position of the input device in relation to the display controls the position of the cursor, such that when a user points directly at the display, the cursor appears at the intersection of the display and the line of sight from an aiming point of the input device. When the device is moved, the cursor appears to move on the display in exact relation to the input device. In addition, a cursor command unit allows the user to virtually operate the input device so that changes in the position of the device invoke mouse functions. The computer pointing input device is designed to operate with a computer having a processor through a computer communication device.

The input device includes a housing and may include an image-capturing component. The input device additionally may include an internal processing unit, a battery, an array component, an array aperture, a wireless or wired communication device and the cursor command unit. The housing may have a front aperture, a rear aperture or an aperture in any portion of the housing that would allow the input device to obtain images. The image-capturing component acquires images from the appropriate aperture for the method of image acquisition used. The image-capturing component may include multiple illuminators that illuminate a surface in front of the device when the image-capturing component acquires an image through the front aperture, or behind the device when the image-capturing component acquires an image through the rear aperture.

The computer pointing input device may additionally include a rotating ball connected to the end of the input device. The rotating ball may have illuminators and a rear aperture, such that an image may be acquired through the rear aperture of the device. The input device may include a transmitter that communicates wirelessly with the computer or a cable connecting the device directly to the computer. The device may additionally have a traditional mouse wheel and traditional mouse buttons on the housing so that a user is able to optionally utilize these additional features.

The computer pointing input device makes use of various methods of aligning the cursor image along the line of sight of the computer pointing input device. In a first method, the device obtains a picture of the cursor image and uses the picture of the cursor image itself to align the device and the cursor. The computer pointing input device is aimed at the display. The image-capturing component continuously acquires pictures of the area on the display in the field of vision through the front aperture along the line of sight of the device. The picture is conveyed to the processor through the wired or wireless communication device. A dataset center zone of the field of vision is determined. The processor then scans the image to determine whether the mouse cursor image is found within each successive image conveyed to the processor. When the cursor image is found, a determination is made as to whether or not the center coordinates of the cursor object are within the dataset center zone of the image. If the center coordinates of the cursor image are found within the center zone of the field of vision image, the device is thereafter “locked” onto the cursor image.

Once the device is “locked”, the processor is able to take into account movement of the device and move the cursor image directly with the device. After the pointing device is “locked”, coordinates are assigned for the area just outside the boundary of the cursor object and saved as a cursor boundary dataset. The device may then be moved, and the processor determines whether the cursor image is found within the loaded images. When the cursor image is found, then the cursor object coordinates are compared to the cursor boundary dataset, and if any of the cursor object edge coordinates correspond with the cursor boundary coordinates, then the processor is notified that the cursor object has moved out of the center of the field of vision and the cursor object is moved in a counter direction until it is again centered.

The second method of aligning the cursor image with the device is to first “lock” the input device with the cursor image. Before the device is activated, the user holds the device in such a way that the line of sight of the device aligns with the cursor image. The device is then activated. Images are acquired either through the front aperture from a surface in front of the device, through the rear aperture from a surface in back of the device, or may be acquired through any aperture built into the housing from a surface viewed through the aperture and may be illuminated by the illuminators. The array aperture, located on the side of the array component closest to the aperture through which the images are acquired, focuses the images onto the array component. As noted above, the array aperture is an optional component. The images are converted by the internal processing unit to a format readable by the processor, and the information is transmitted to the processor by the wired or wireless communication device. Successive images are compared, and the processor is able to determine changes in the direction of the device based on the slight variations noted between successive images acquired as a result of the movement of the device away from the zeroed point determined at the first “locked” position. The processor then moves the cursor object based on the movement of the input device.

In a third method of aligning the cursor image with the line of sight of the device, the device uses infrared, ultrasonic, or radio transmitters in conjunction with a sensor array attached to the monitor to determine the line of sight of the device. The ranges, or distances from points on the device to the monitor, are determined, and a vector is calculated through the points and the monitor. The x and y coordinates of the intersection of the vector and the display are determined, and when the input device is moved, the cursor image is directed by the processor to move in line with the line of sight of the device. While a vector through points on the device is discussed, the position of the device may be determined through any method that uses transmitters situated on the device and a sensor array. In alternate embodiments, the sensor array may be positioned on a desk top, behind the device or in any location so that the sensor array can pick up the signals sent by the transmitters to the sensor array and thereby determine the position of the input device.

For a given display, such as a computer monitor, coordinates can be broken into the usual Cartesian coordinate system, with x representing horizontal coordinates and y representing vertical coordinates. For the below, the upper left-hand corner of the monitor represents (x,y) coordinates of (0,0), and the z coordinate represents the third dimension, which is orthogonal to the plane of the monitor. For a control unit held away from the monitor in the z-direction, with a first transmitter, A, being located at the front of the control until and a second transmitter, B, being located at the rear of the control unit, the coordinates of transmitter A are given by (Xa,Ya,Za) and the coordinates of transmitter B are given by (Xb,Yb,Zb). Each corner of the monitor has ultrasonic receivers and from the time of flight, adjusted for atmospheric conditions, the x, y and z coordinates of each transmitter can be determined relative to the monitor plane.

In order to solve for the line-of-sight termination point (VRPx and VRPy) on the monitor plane, we define Z1=Zb−Za (where Z1 is the sub-length of Zb) and Z2=Zb−Z1. We further define:

DShadowLength={square root over (((Xa−Xb)·(Xa−Xb)+(Yb−Ya)·(Yb−Ya)))}, and also

DLength=\sqrt{(DShadowLength·2)+(Z1·Z1)}.

In order to determine the virtual beam length, we define:

$$θ = {sin}^{- 1} ( \frac{Z 1}{DLength} ) and VBLength = \frac{Z 2}{sin θ} .$$

### Then,

$$ShadowBeamLength = \sqrt{{VBLength}^{2} - Z {2}^{2}} , \\ so θ = {sin}^{- 1} ( \frac{Yb - Ya}{DShadowLength} ) .$$

Thus, we finally have:

VRPx=ABS(Xa)+(cos θ·ShadowBeamLength); and

VRPy=Ya−(sin θ·ShadowBeamLength).

The cursor command unit allows a user to operate the computer pointing input device without traditional mouse buttons. The cursor command unit includes an infrared, ultrasonic, radio or magnetic transmitter/receiver unit. A signal is sent out from the cursor command unit and reflected back to the unit for the infrared, ultrasonic, or radio units. A disturbance is sent from the device when a magnetic unit is used. Either the processor, the cursor command unit or the internal processing unit is able to determine changes in distance from the cursor command unit to the display when the device is moved between a first distance and a second distance. Time intervals between distances are also determined. The information as to distance and time intervals is sent to the processor, and depending on the difference in distances and the time intervals between distances, the processor is instructed to execute a specific cursor command.

Alternatively, the computer input device may include a directional light source, such as a laser pointer, for generating a directional light beam, which is to be aimed at the computer display. In this embodiment, an optical sensor is provided for sensing the directional light beam and generating a set of directional coordinates corresponding to the directional light source. The set of directional coordinates is used for positioning the computer cursor on the computer monitor, and the optical sensor is in communication with the computer for transmitting the set of coordinates. The optical sensor may be a digital camera or the like. The light beam impinging upon the display produces an impingement point, and the optical sensor, positioned adjacent to the display and towards the display, reads the position of the impingement point. It should be understood that the computer monitor is used for illustration only, and that any type of computer display may be used, e.g., a projection display. It should also be understood that multiple impingement spots may be tracked.

In another embodiment, the user may have one or more light emitting diodes mounted on the user's fingers. A camera may be aimed at the user's fingers to detect the position of the LED light beam(s). The camera may be calibrated so that relative movement of the finger-mounted LED is translated into instructions for movement of a cursor on a display screen. The camera may communicate changes in pixel position of images of the LED beams generated by the camera and communicate these pixel position changes to software residing on a computer, which converts the pixel changes to cursor move functions similar to mousemove, or the camera may have a processing unit incorporated therein that translates pixel position change into the cursor move instructions and communicates these instructions to a processor unit connected to the display. When more than one LED is involved, at least one of the LED beams may be modulated with instructions analogous to mouse click instructions, i.e., right click, left click, double click, etc.

As a further alternative, the directional light source may be mounted to a mobile support surface through the use of a clip or the like. The mobile support surface may be a non-computerized device, such as a toy gun, which the user wishes to transform into a video game or computer controller. Further, an auxiliary control device having a user interface may be provided. The auxiliary control device preferably includes buttons or other inputs for generating control functions that are not associated with the cursor position. The auxiliary control device is adapted for mounting to the mobile support surface, and is in communication with the computer. It should be understood that multiple targets may be tracked for multiple players.

These and other features of the present invention will become readily apparent upon further review of the following specification and drawings.

### BRIEF DESCRIPTION OF THE DRAWINGS

FIG. 1 is an environmental, perspective view of a computer pointing input device according to the present invention.

FIG. 2 is a block diagram of a typical computer system for use with the computer pointing input device according to the present invention.

FIG. 3 is a detailed perspective view of the computer pointing input device according to a first embodiment of the present invention.

FIG. 4 is an exploded view of the computer pointing input device of FIG. 3.

FIG. 5 is a detailed perspective view of a computer pointing input device according to a second embodiment of the present invention.

FIG. 6 is a detailed perspective view of a computer pointing input device according to a third embodiment of the present invention.

FIG. 7 is a flowchart of a first method of aligning the cursor image with the computer pointing input device according to the present invention.

FIG. 8 is a flowchart showing a continuation of the first method of aligning the cursor image with the computer pointing input device according to the present invention.

FIG. 9 is an environmental, perspective view of the computer pointing input device according to the present invention showing a sensor array disposed on the monitor.

FIG. 10 is a flowchart of a second method of aligning the cursor image with the computer pointing input device according to the present invention.

FIG. 11 is a flowchart of the operation of the cursor command unit of the computer pointing input device according to the present invention.

FIG. 12 is an environmental, perspective view of an alternative embodiment of a computer pointing device according to the present invention.

FIG. 13 is a partially exploded perspective view of another alternative embodiment of a computer pointing device according to the present invention.

FIG. 14 is an environmental, perspective view of another alternative embodiment of a computer pointing device according to the present invention.

FIG. 15 is a flowchart illustrating method steps of another alternative embodiment of the computer pointing device according to the present invention.

FIG. 16 is an environmental, perspective view of another alternative embodiment of a computer pointing device according to the present invention.

Similar reference characters denote corresponding features consistently throughout the attached drawings.

### DETAILED DESCRIPTION OF THE PREFERRED EMBODIMENTS

The present invention is a computer pointing input device that allows a user to determine the position of a cursor on a computer display. The position of the input device in relation to the display controls the position of the cursor, so that when a user points directly at the display, the cursor appears at the intersection of the line of sight of the input device and the display. When the device is moved, the cursor appears to move on the display in exact relation to the input device. In addition, a cursor command unit allows the user to virtually operate the input device. Changes in the position of the device allow the user to spatially invoke mouse functions.

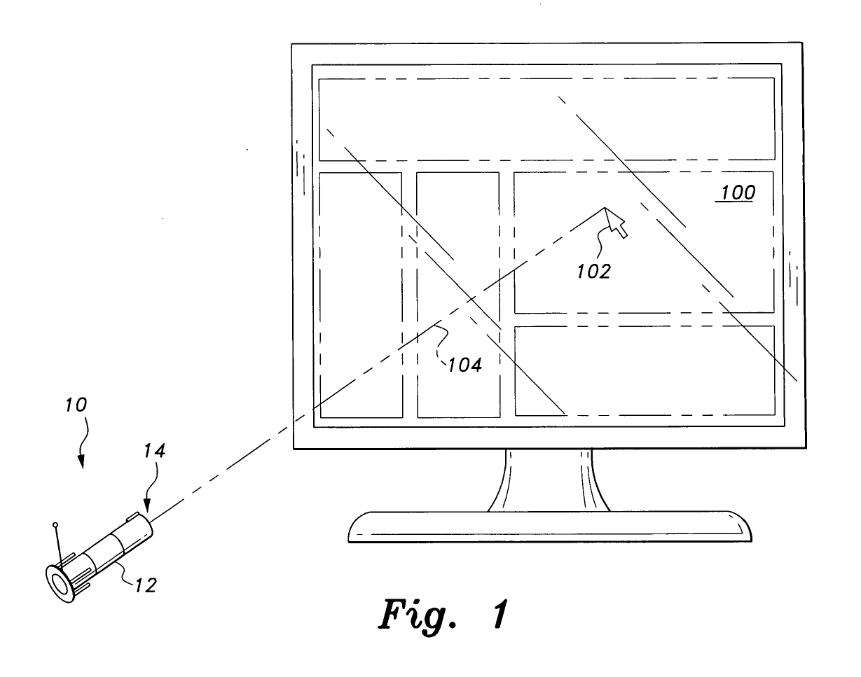

Referring first to FIG. 1, an environmental, perspective view of the computer pointing input device 10 is shown. The input device 10 includes a housing 12 having a front aiming point 14. After the device 10 is activated, when the device 10 is aimed at the display 100, the cursor 102 appears to align along the line of sight 104 of the aiming point 14 of the input device 10. Upon movement in any direction of the device 10, the cursor 102 will reposition at the intersection of the line of sight 104 between the aiming point 14 and the display 100. While a cursor image is discussed, the device 10 may be used with any visual object shown on a display 100.

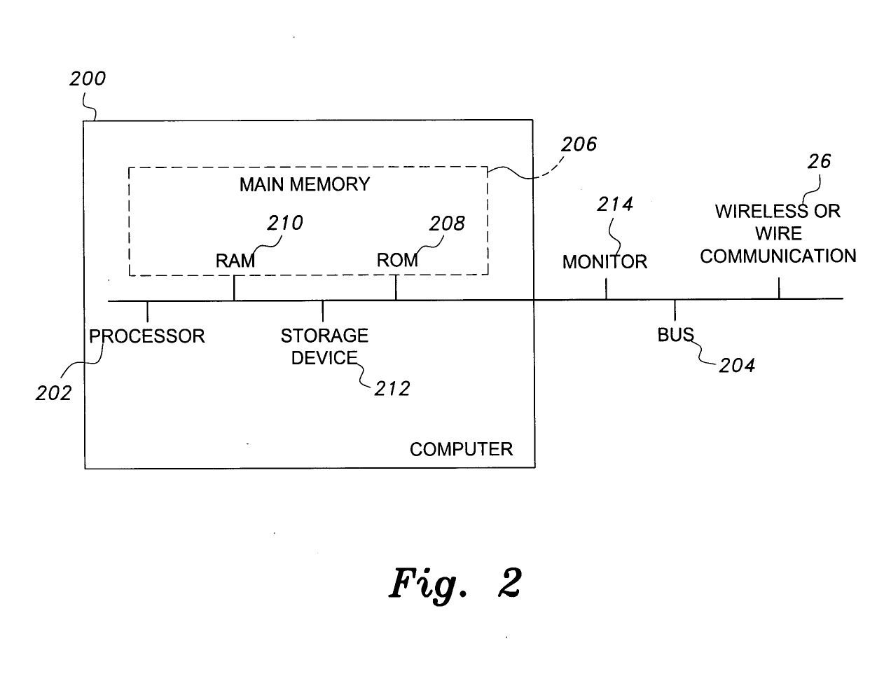

The computer pointing input device 10 is designed to operate with a computer through a wired or wireless communication device 26. FIG. 2 shows a typical personal computer system for use in carrying out the present invention.

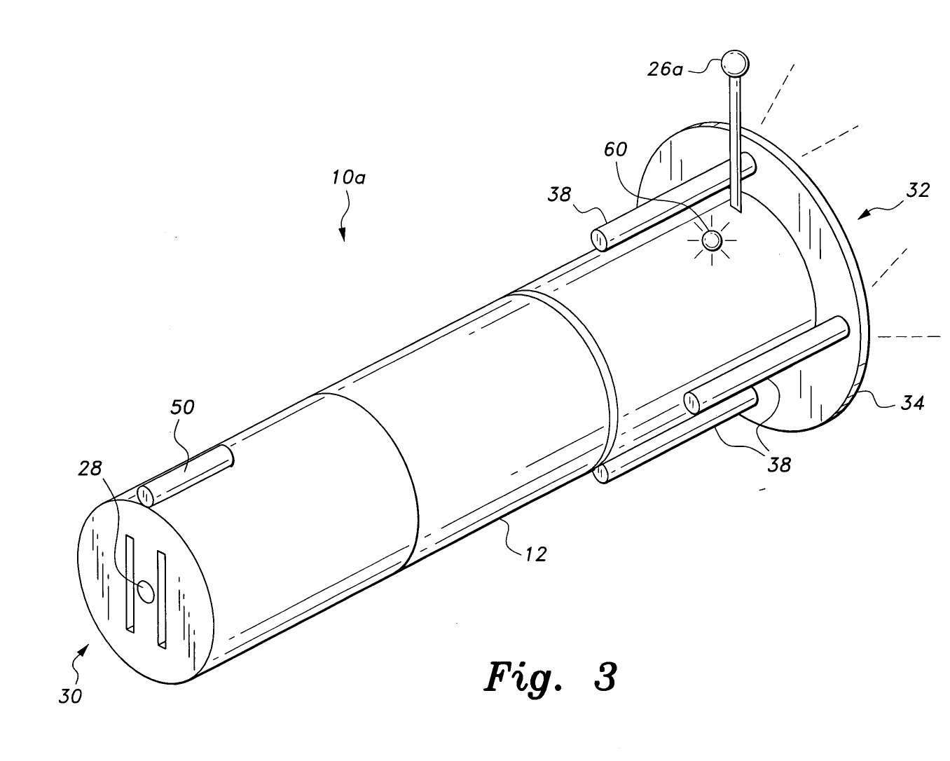

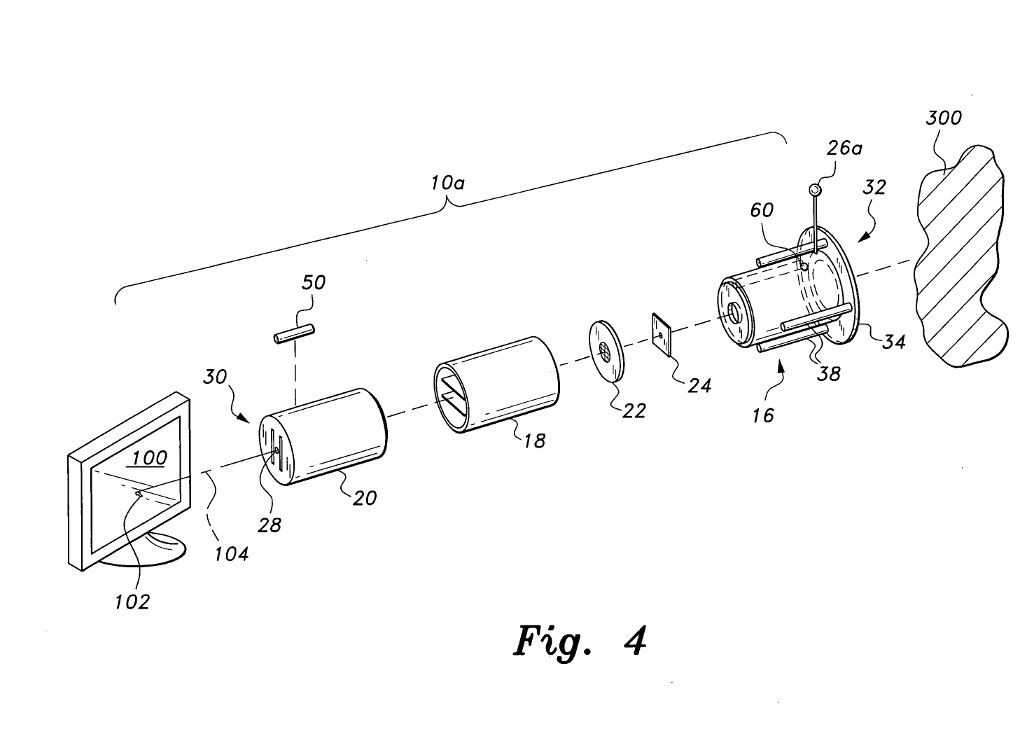

The personal computer system is a conventional system that includes a personal computer 200 having a microprocessor 202 including a central processing unit (CPU), a sequencer, and an arithmetic logic unit (ALU), connected by a bus 204 or buses to an area of main memory 206 for executing program code under the direction of the microprocessor 202, main memory 206 including read-only memory (ROM) 208 and random access memory (RAM) 210. The personal computer 200 also has a storage device 212. The personal computer system also comprises peripheral devices, such as a display monitor 214. The personal computer 200 may be directly connected to the computer pointing input device 10 through a wireless or wired communication device 26, such as a transmitter 26a (shown more clearly in FIGS. 3 and 4) connected to the device 10 for transmitting information and a receiver connected to the personal computer 200 for receiving the information sent by the transmitter, or may be a wired connection, such as a 1394, USB, or DV cable. While a personal computer system is shown, the device 10 may operate with any system using a processor.

It will be understood that the term storage device 212 refers to a device or means for storing and retrieving data or program code on any computer readable medium, and includes a hard disk drive, a floppy drive or floppy disk, a compact disk drive or compact disk, a digital video disk (DVD) drive or DVD disk, a ZIP drive or ZIP disk, magnetic tape and any other magnetic medium, punch cards, paper tape, memory chips, or any other medium from which a computer can read.

Turning now to FIGS. 3-6, various embodiments of the computer-pointing input device 10 are shown. FIG. 4 shows an exploded view of the components of the device 10. A computer 100 is shown diagrammatically in FIG. 4 for purposes of illustration, and is not drawn to scale. While FIG. 4 shows the numerous components that make up the structure of the device 10, not every component shown in FIG. 4 is essential to the device 10, and certain components may be subtracted or arranged in a different manner depending on the embodiment of the device 10 involved, as will be explained below.

FIGS. 3 and 4 are perspective and exploded views, respectively, of a first embodiment of the computer pointing input device 10a. The input device 10a has a housing 12 and may include an image-capturing component 16. The input device 10a additionally may include an internal processing unit 18, a battery 20, an array component 22, an array aperture 24, a wireless or wired communication device 26 (a wireless device 26a being shown in FIGS. 3 and 4) and a cursor command unit 50.

The housing 12 may be any of a number of housing devices, including a handheld mouse, a gun-shaped shooting device, a pen-shaped pointer, a device that fits over a user's finger, or any other similar structure. The housing 12 may have a front aperture 28 defined within the front end 30 of the housing 12 or a rear aperture 32 defined within the back end 34 of the housing 12. Although front 28 and rear 32 apertures are shown, an aperture capable of obtaining images through any position from the housing may be used. While both the front 28 and rear 32 apertures are shown in FIG. 4, generally only one of the two apertures 28 and 32 is necessary for a given embodiment of the present invention. If the front aperture 28 is defined within the front end 30 of the housing 12, the front aperture 28 is the aiming point 14 of the device 10a.

The image-capturing component 16 is disposed within the housing 12. The image-capturing component 16 may be one of, or any combination of, a ray lens telescope, a digital imaging device, a light amplification device, a radiation detection system, or any other type of image-capturing device. The image-capturing component 16 acquires images from the front aperture 28, the rear aperture 32, or an aperture built into some other portion of the housing 12, based upon the method of image acquisition used. The image-capturing component 16 may be used in conjunction with the array component 22 and the array aperture 24, or the array component 22 and array aperture 24 may be omitted, depending on the method through which the device 10 aligns itself along the line of sight 104 of the device 10.

The array component 22 may be a charge-coupled device (CCD) or CMOS array or any other array capable of detecting a heat, sound, or radiation signature that is conveyed to the internal processing unit 18. When the array component 22 and the array aperture 24 are utilized, the array aperture 24 creates a focal point of the image being acquired. The array aperture 24 is disposed next to the array component 22 on the side of the array component 22 through which the image is being captured. As shown in FIG. 4, if an image, for example, image 300, is being acquired through the rear aperture 32, the array aperture 24 is positioned on the side of the array component 22 that is closest to the rear aperture 32. If an image, for example, display 100, is being acquired through the front aperture 28, the array aperture 24 is positioned on the side of the array component 22 that is closest to the front aperture 28.

The image-capturing component 16 may include multiple illuminators 38 that illuminate a surface, for example, display 100, in front of the device 10 when the image-capturing component 16 acquires an image through the front aperture 28 and the image requires illumination in order to be acquired. The illuminators 38 may illuminate a surface, for example, image 300, from the back of the input device 10 when the image-capturing component 16 acquires an image from the rear aperture 32. Image 300 may be any image obtained from behind the computer pointing device 10, for example, a shirt, a hand, or a face. Additionally, if the aperture is defined within the housing other than in the front or the rear of the housing, the image is obtained from the surface (i.e., a wall or ceiling) seen through the aperture.

The wireless or wire communication device 26 may be a transmitter 26a connected to the input device 10a for use with a receiver connected to the processor 202. A device status light 60 may be located on the housing 12 of the device 10. The cursor command unit 50 may be retained on the front of the unit.

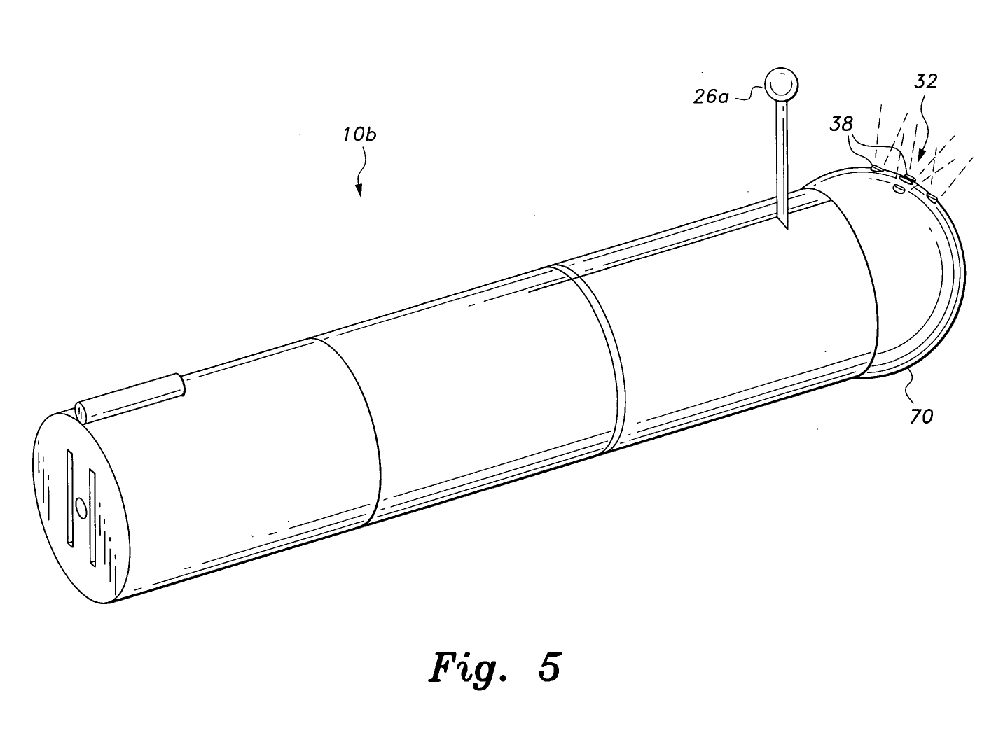

Turning now to FIG. 5, a second embodiment of the computer pointing input device 10b is shown. In this embodiment, a rotating ball 70 is connected to the end of the input device 10b. The ball 70 includes illuminators 38 on the ball 70 and a rear aperture 32, so that an image may be acquired through the rear aperture 32 of the device 10b. The ball 70 may be rotated to create a better position to obtain the image.

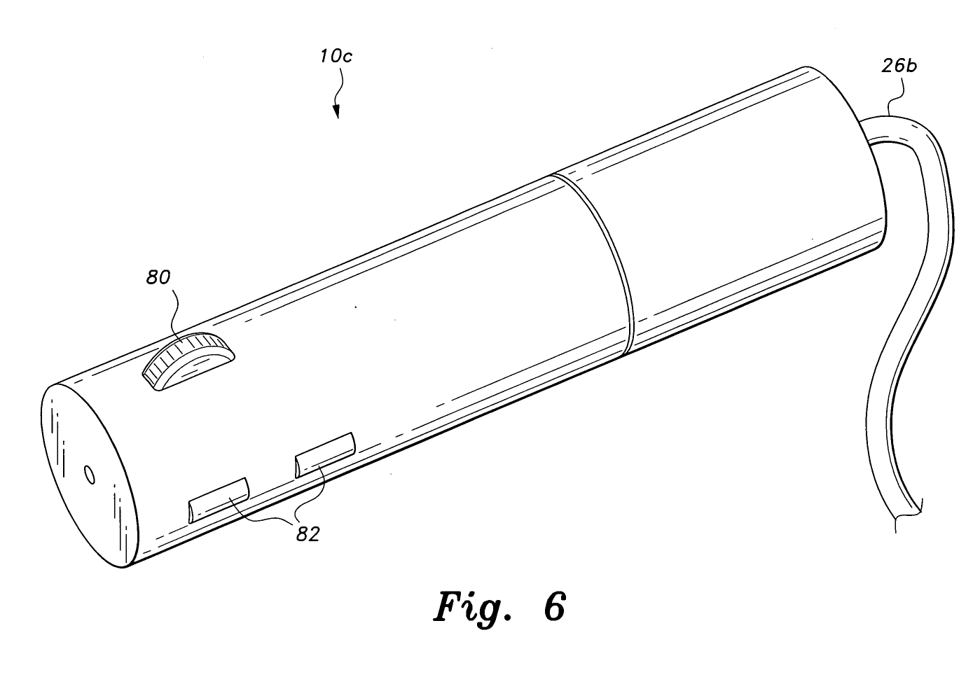

FIG. 6 shows a third embodiment of the computer pointing input device 10c. The device 10c omits the transmitter 26a and substitutes a cable 26b wired directly to the processor 202. In this embodiment, the battery 20 is an unnecessary component and is therefore omitted. Additionally, a traditional mouse wheel 80 and traditional mouse buttons 82 are provided on the housing 12 so that a user is able to optionally utilize these additional features.

While FIGS. 3-6 show a number of embodiments, one skilled in the art will understand that various modifications or substitutions of the disclosed components can be made without departing from the teaching of the present invention. Additionally, the present invention makes use of various methods of aligning the cursor image 102 along the line of sight 104 of the computer pointing input device 10.

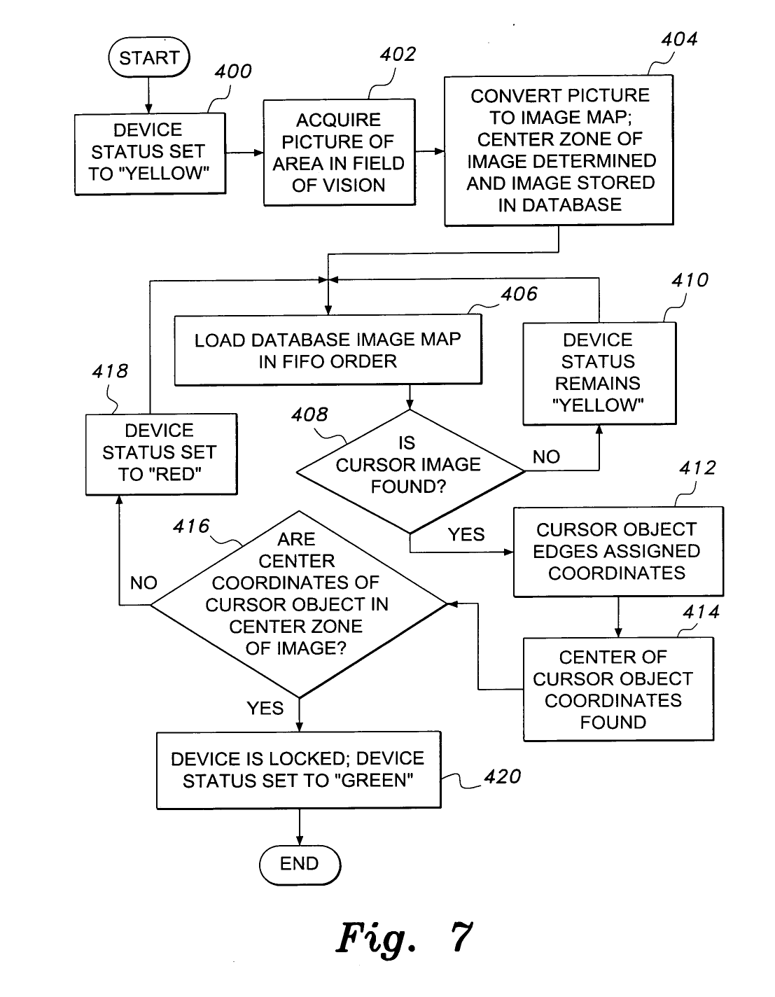

In a first method, the device 10 obtains a picture of the cursor image 102 and uses the picture of the cursor image 102 to align the device 10 and the cursor 102. This method does not require use of the array component 22 and the array aperture 24, and may not require use of the internal processing unit 18. FIG. 7 shows a flowchart illustrating the steps of the method of aligning the cursor image 102 with the line of sight 104 of the device 10 by image acquisition of the cursor image 102 itself. At 400, the status light 60 of the device is set to “yellow”. Setting the status light 60 to “yellow” notifies the user that the cursor image 102 has yet to be found within the field of vision of the device 10. The computer pointing input device 10 is aimed at the display 100. The image-capturing component 16 continuously acquires pictures of the area on the display in the field of vision through the front aperture 28 along the line of sight 104 of the device 10, as indicated at 402. The picture is conveyed to the processor 202 through the wired or wireless communication device 26.

Software loaded on the processor 202 converts the picture to a gray-scale, black and white or color image map at step 404. A center point of the field of vision of each image acquired is determined, the center point being a coordinate of x=0, y=0, where x=0, y=0 is calculated as a coordinate equidistant from the farthest image coordinates acquired within the field of vision at 0, 90, 180 and 270 degrees. A center zone is determined by calculating coordinates of a small zone around the center point and saving these coordinates as a dataset. Each image is then stored in a database.

At step 406, the database image map is loaded in FIFO (first in, first out) order. The processor 202 then scans the image map at step 408 to determine whether the mouse cursor image 102 is found within each successive image conveyed to the processor 202. If the cursor image 102 is not found, the status light 60 located on the device 10 remains “yellow” at step 410, and the processor 202 is instructed to load the database image map again. If the cursor image 102 is found within the image map, as indicated at step 412, the cursor object edges are assigned coordinates and saved as a cursor object edges dataset. At step 414, the x and y coordinates of the center of the cursor object 102 are found. At step 416, a determination is made as to whether or not the center coordinates of the cursor object 102 are within the dataset center zone of the image calculated at step 404. If the center coordinates of the cursor object 102 are not determined to be within the center zone of the image, the device status light 60 is set to “red” at 418, notifying the user that the “lock-on” is near and the cursor object 102 is close to being centered along the line of sight 104 of the device 10. If the center coordinates are found within the center zone of the image, at 420, the device 10 is “locked” and the device status light 60 is set to “green,” notifying the user that the device 10 has “locked” onto the cursor image 102. The device 10 being “locked” refers to the fact that the line of sight 14 of the computer pointing input device 10 is aligned with the cursor image 102 displayed on the screen.

While the status light makes use of “red,” “yellow,” and “green” settings, any other convenient indicator of status may be used in place of these indicating settings.

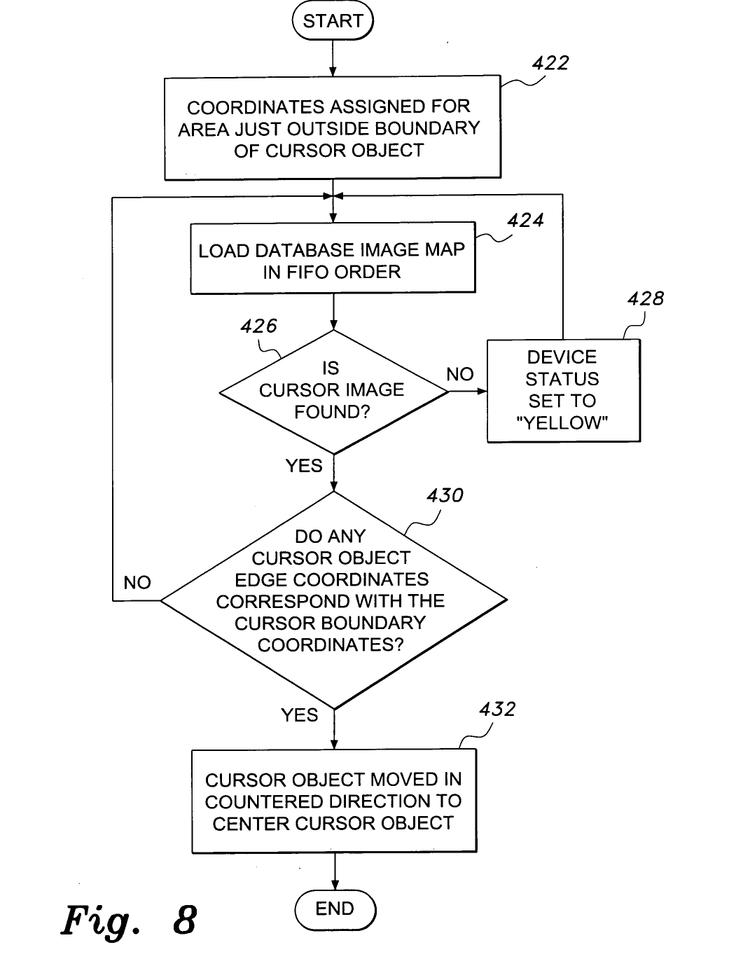

Once the device 10 is “locked”, the processor 202 is able to take into account movement of the device 10 and move the cursor image 102 directly with the device 10. Turning now to FIG. 8, a flowchart is shown that describes how the software maintains the cursor image 102 aligned with the line of sight 14 when the input device 10 is subsequently moved to point to a different location on the display 100.

After the pointing device 10 is “locked”, at 422, coordinates are assigned for the area just outside the boundary of the cursor object 102 and saved as a cursor boundary dataset. The device 10 may then be moved, and at step 424, the database image map is again loaded in FIFO order, essentially updating the movement of the device 10. The software determines whether the cursor image 102 is found within the images loaded at 426. If the cursor image 102 is not found, the device status light 60 is set to “yellow” at step 428 and the database image map is again loaded until the cursor image 102 is found. If the cursor image 102 is found, at 430, then the cursor object edge coordinates, determined at 412, are compared to the cursor boundary dataset. If any of the cursor object edge coordinates correspond with the cursor boundary coordinates, then the one edge has overlapped the other and, at 432, the cursor object 102 is moved in a countered direction until the cursor object 102 is again centered in the field of vision of the computer pointing input device 10.

In the second method of aligning the cursor image 102 with the device 10, the device 10 is first “locked” onto the cursor image 102. Before the device 10 is activated, the user holds the device 10 in such a way that the line of sight 104 of the device 10 aligns with the cursor image 102 displayed on the monitor 214. The device 10 is then activated, and the processor 202 is notified that the device 10 has zeroed onto the cursor image 102, signifying that the device 10 is “locked” to the cursor image 102. Although the device 10 should generally zero in on the center of the cursor image 102, the device 10 may be zeroed at any point at which the user intends to align the line of sight of the device 10 and the display 100.

In this example, the array component 22 and the array aperture 24 are used in conjuncture with the device's internal processing unit 18. The illuminators 38 direct illumination onto a surface in front of the device 10, for example, display 100, if the image is intended to be captured through the front aperture 28. The illumination components 38 illuminate a surface in back of the device 10, for example, image 300 shown in FIG. 3, if the image is intended to be captured through the rear aperture 32. The image-capturing component 16 continuously acquires images through the front or rear aperture 28 or 32 of the device 10, and focuses the image onto the array component 22. The images are then converted by the internal processing unit 18 to a format readable by the processor 202. The information is conveyed to the processor 202 by the wired or wireless communication device 26. Successive images are compared, and the processor 202 is able to determine changes in the direction of the device 10 based on the slight variations noted between successive images acquired as a result of the movement of the device 10 away from the zeroed point determined at the first “locked” position. The processor 202 will then move the cursor object 102 based on the movement of the device 10 in the x or y direction.

While the foregoing description relates that the device 10 is moved relative to a fixed monitor 214, allowing for the acquisition of multiple images that may be compared, alternatively the device 10 may be held stationary, and the images may be acquired and compared through movement of the surface from which the images are being obtained relative to the device 10 itself. For example, the device 10 may be held near a user's face at a position close to the user's eyes. The pointing device 10 may be set in such a manner that the device 10 may acquire images of the eye's position relative to a “zeroed” point to determine the direction the cursor image 102 is to move.

In a third method, the device 10 uses infrared, ultrasonic, or radio transmitters in conjunction with a sensor array 90 attached to the monitor 212 to determine the line of sight 14 of the device 10. The device 10 may also make use of a magnetic field in conjunction with a sensor array 90 to determine the line of sight 14 of the device. When the input device 10 is moved, the cursor image 102 is directed by the processor 202 to move in correspondence to positions mathematically determined by the intersection of an imaginary line projected through points at the front end 30 and back end 34 of the device 10 with the display 100. Use of the infrared, ultrasonic, radio or magnetic transmitters does not require the use of the internal array component 22 or the array aperture 24, and may not require use of the internal processing unit 18. While the projection of an imaginary line through points at the front 30 and back 34 of the device 10 is disclosed, the position of the device 10 may be determined through any method that uses transmitters situated on the device 10 and a sensor array 90. For example, numerous transmitters may be used anywhere on the device 10, not necessarily in the front 30 and rear 34 ends of the device 10, so long as an imaginary line extending through points on the device 10 may be projected to extend toward, and intersect with, the display 100.

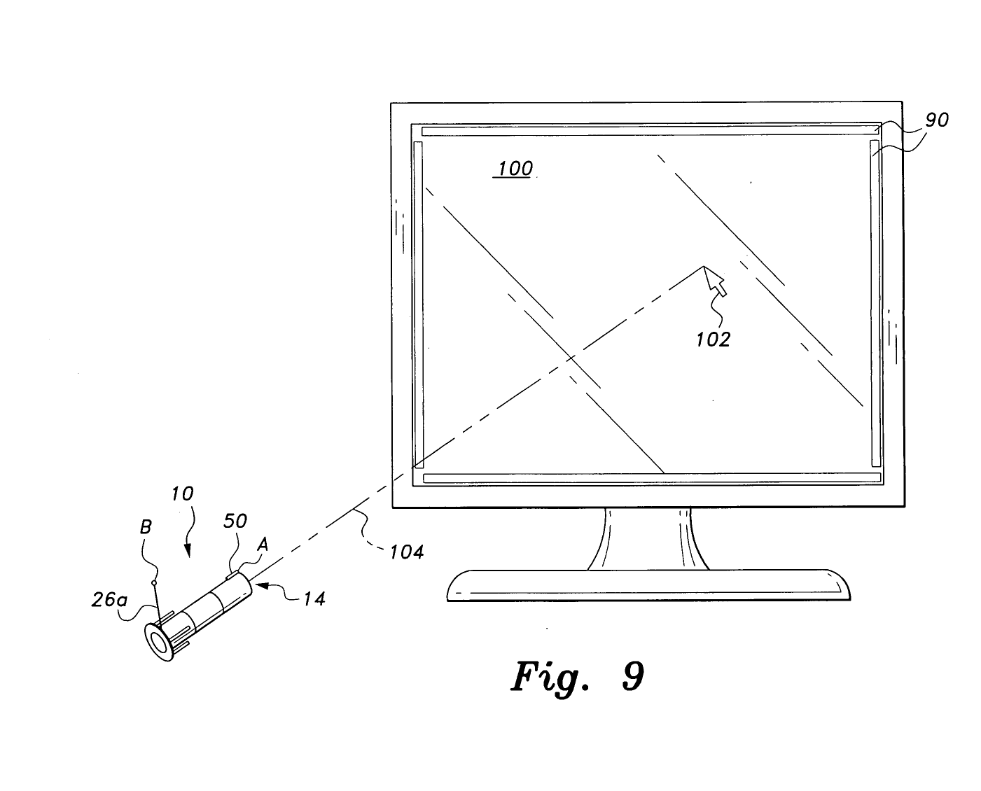

Turning now to FIG. 9, the computer pointing input device 10 is shown being used with a sensor array 90. The sensor array 90 is attached directly to, closely adjacent to, or directly in front of the computer monitor 214 and is coupled to the processor 202. The sensor array 90 includes multiple receivers able to pick up signals sent from the computer pointing input device 10. The cursor command unit 50 contains an infrared, ultrasonic, radio or magnetic transmitter that is able to transmit a first signal or magnetic field from point A, which is the front end 30 of the device 10, to the sensor array 90. The wireless communication device, transmitter 26a, is able to transmit a second signal from point B, which is the back end 34 of the device 10, to the sensor array 90. The signals emitted from points A and B are picked up by the sensor array 90 that is able to triangulate their positions above the reference plane, which is the display monitor 214. In alternate embodiments, the sensor array 90 may be positioned on a desk top, behind the device 10, or in any location so that the sensor array 90 can pick up the signals sent by the transmitters to the sensor array 90 and then determine the position of the input device 10 in relation to the display 100.

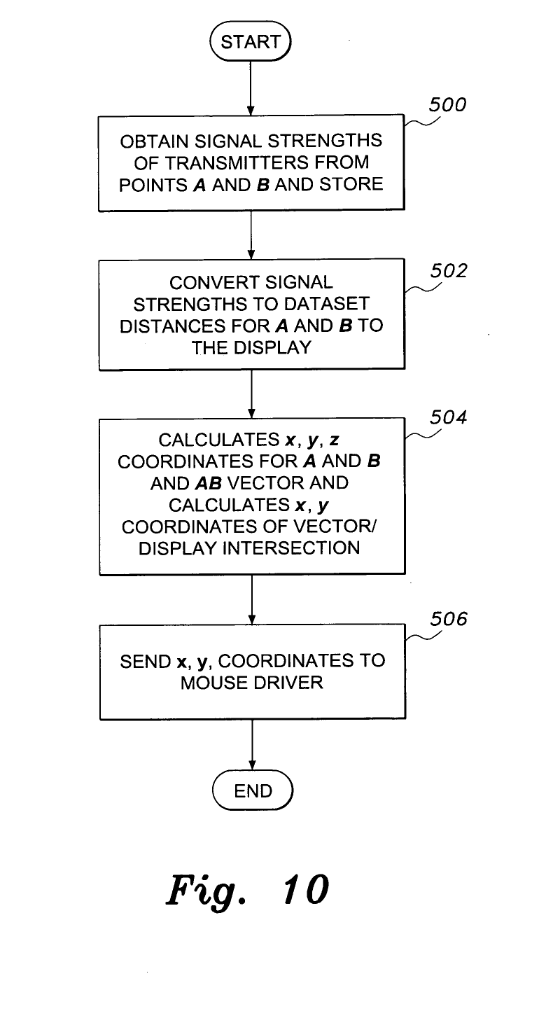

FIG. 10 shows a flowchart of the method of aligning the cursor image 102 with the line of sight 104 of the device 10 using a sensor array 90. At step 500, the signal strengths of the transmitters at point A and point B are obtained by the sensor array 90, sent to the processor 202 and stored in a dataset. The signal strengths are converted to dataset range distances from point A to the display 100 and point B to the display 100 at 502. At 504, the x, y, and z coordinates are calculated for point A and point B above the display 100 and an AB vector is calculated through points A and B. Then the x and y coordinates of the intersection of the AB vector and the display 100 are determined. The x and y coordinates of the vector/display intersection are sent to the processor 202 to direct the computer's mouse driver to move the cursor image 102 in relation to the vector/display intersection. While two points A and B are discussed, any number of transmitters may be used on the device, as long as an imaginary line that intersects the display 100 can be projected through two or more points on the device 10 that intersects the display 100, thereby allowing the processor 202 to ascertain the line of sight of the device 10 and direct the mouse cursor 102 to move to a position determined by the intersection of the imaginary line and the display 100.

The cursor command unit 50 (shown in FIGS. 1 and 3-5) allows a user to operate the computer pointing input device 10 without traditional mouse buttons. Virtual invocation of mouse functions allows for increased efficiency in performing the functions, as virtual invocation is more ergonomic than the typical electromechanical configuration of a mouse. The cursor command unit 50 is equipped with an infrared transmitter/receiver unit or any other type of transmitting and receiving unit that would allow for a signal to be sent to and received from the display 100.

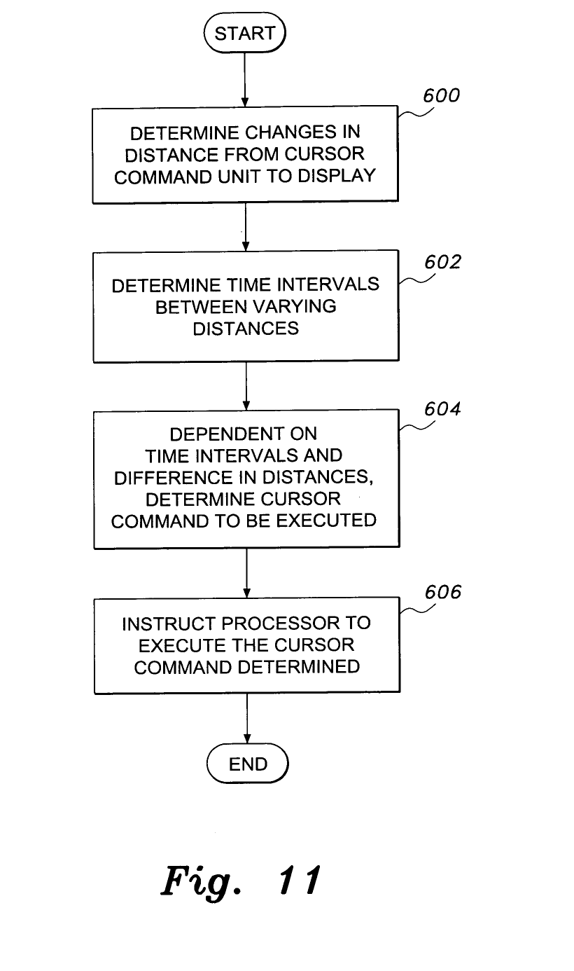

FIG. 11 shows a flowchart of the method by which cursor commands may be executed. A signal is transmitted from the cursor command unit 50 and reflected back to the unit 50. When the device 10 is moved between a first distance and a second distance, the difference in time for the signal to return to the cursor command unit 50 is noted either by a processing unit within the cursor command unit 50, by the internal processing unit 18 within the device 10 to which the cursor command unit 50 may be coupled, or by the computer processor 202 to which information is sent by the cursor command unit 50. Either the processor 202, the cursor command unit 50 or the internal processing unit 18 is able to determine changes in distance from the cursor command unit 50 to the display 100 at 600. At step 602, time intervals between varying distances are also determined. The information as to varying distances and time intervals is sent to the processor 202 by the wired or wireless communication device 26. Depending upon the difference in distances and the time intervals between various distances, the cursor command to be executed is determined at 604. At 606, the processor 202 is instructed to execute the cursor command so determined.

An example illustrating the above method is as follows. The device 10 is moved from a first position, D1, to a second position, D2. The device 10 is maintained at the D2 position for a one second interval and then returned to the D1 position. The processor 202 would determine the cursor command, for example a “left click” command, based on the spatial difference between D1 and D2 and the timing interval maintained at D2 before returning the device to position D1.

While the line of sight 104 of the device 10 has been shown as the front aiming point of the device 10, the line of sight 104 may be from any aiming or other point on the device 10 located at any position appropriate for the user.

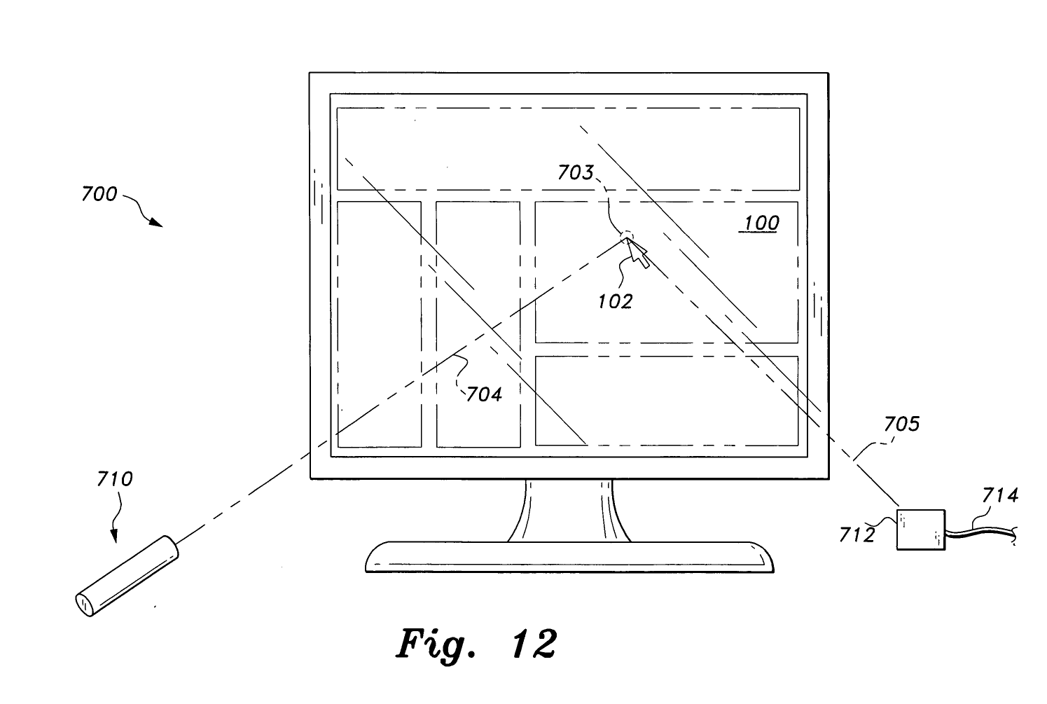

In the alternative embodiment of FIG. 12, the computer input device 700 includes a directional light source, such as exemplary laser pointer 710, for generating a directional light beam 704, which is to be aimed at the computer display 100 for controlling cursor 102. The directional light source may be any suitable light source, such as the exemplary laser pointer 710, one or more light emitting diodes, one or more lamps, or the like. Preferably, the directional light source produces beam 704 in the infrared or near infrared spectra.

An optical sensor 712 is further provided for sensing the directional light beam 704 and for generating a set of directional coordinates corresponding to the directional light source 710. The set of directional coordinates is used for positioning the computer cursor 102 on the computer monitor or display 100, and the optical sensor 712 is in communication with the computer via cable 714 for transmitting the set of coordinates to control the movement of cursor 102. The light beam 704, impinging upon the display screen 100, produces an impingement point 703 or dot (exaggerated in size in FIG. 12 for exemplary purposes), and the optical sensor 712, positioned adjacent and towards the display 100, tracks the dot and reads the position of the impingement point 703 (shown by directional line segment 705).

In FIG. 12, the sensor 712 is shown as being positioned off to the side of display 100. This is shown for exemplary purposes only, and the sensor 712 may be positioned in any suitable location with respect to the display 100. The optical sensor may be any suitable optical or light sensor, such as exemplary digital camera 712. Cable 714 may be a USB cable, or, alternatively, the sensor 712 may communicate with the computer through wireless communication. Camera 712 preferably includes narrow-band pass filters for the particular frequency or frequency spectrum generated by the light source 710. By using infrared or near infrared beams, the impingement spot 703 on display 100 will be invisible to the user, but will be able to be read by camera 712. The camera 712, as described above, includes a narrow band filter, allowing the camera to filter the other frequencies being generated by the display 100 (i.e., frequencies in the invisible spectrum) and only read the infrared or near infrared frequencies from the impingement point 703. In the preferred embodiment, the light source 710 is a laser pointer, as shown, emitting light beam 704 in the infrared or near infrared band, and camera 712 is a digital camera with narrow band filters also in the infrared or near infrared bands.

In the embodiment of FIG. 12, a single light source is shown, producing a single impingement spot. It should be understood that multiple light sources may be utilized for producing multiple impingement spots (for example, for a multi-player game, or for the inclusion of multiple command functions) with the camera tracking the multiple spots. Alternatively, a beam splitter or the like may be provided for producing multiple impingement spots from a single light source.

Although any suitable camera may be used, camera 712 preferably includes a housing (formed from plastic or the like) having a pinhole lens. The housing is lightproof (to remove interference by ambient light), and a secondary pinhole may be provided to focus and scale the desired image onto the photodiode (or other photodetector) within the housing.

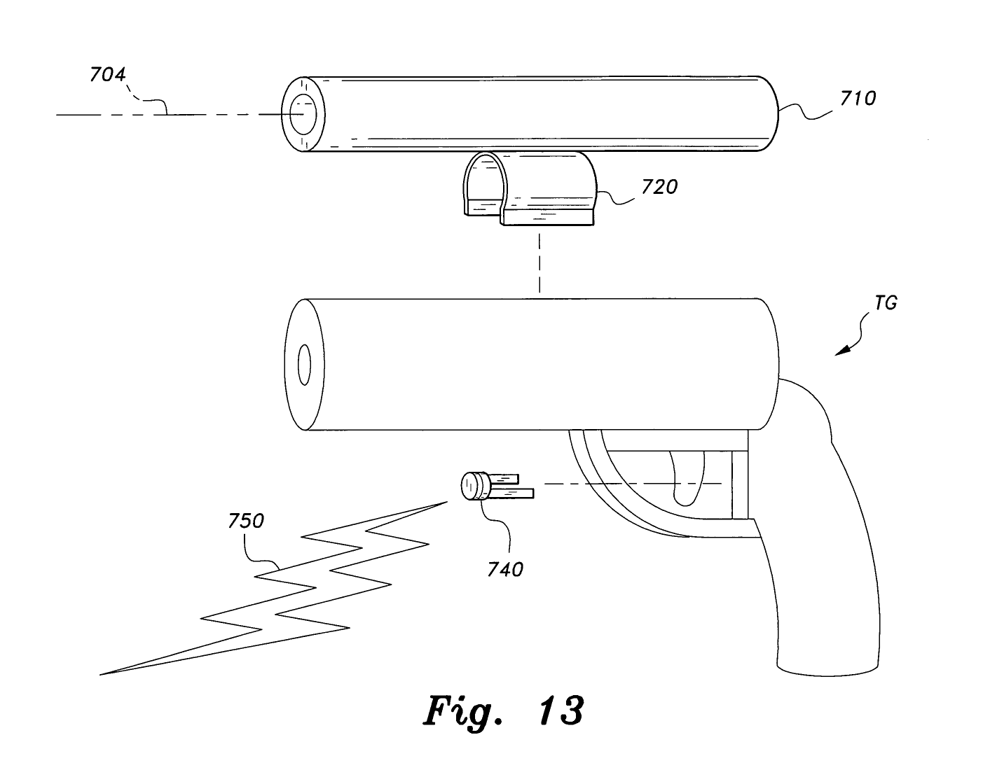

As a further alternative, as shown in FIG. 13, the directional light source 710 may be mounted to a mobile support surface through the use of a clip 720 or the like. The mobile support surface may be a non-computerized device that the user wishes to transform into a video game or computer controller, such as exemplary toy gun TG. Further, an auxiliary control device 730 having a user interface may be provided. The auxiliary control device 730 preferably includes buttons or other inputs for generating control functions that are not associated with the cursor position. The auxiliary control device 730 is adapted for mounting to the mobile support surface, and is in communication with the computer via an interface, which may include cables or wires or, as shown, is preferably a wireless interface, transmitting wireless control signals 750.

In the example of FIG. 13, the auxiliary control device includes a pressure sensor and is positioned behind the trigger of toy gun TG. In this embodiment, although the generated light beam 704 may be used for controlling cursor movement, no other control signals are provided by the light source. For the alternative embodiments, obviously control signals may be associated with the image, such as a modulated signal in a displayed dot being tracked and detected by a photodiode in the camera housing. Modulation may occur through inclusion of a pulsed signal, generated by an optical chopper, a controlled, pulsed power source, or the like. Auxiliary control device 730 allows a trigger activation signal, for example, to be transmitted for game play (in this example). It should be understood that auxiliary control device 730 may be any suitable device. For example, a foot pedal may be added for a video game, which simulates driving or walking. Auxiliary control device 730 may further include feedback units, simulating a gun kick or the like.

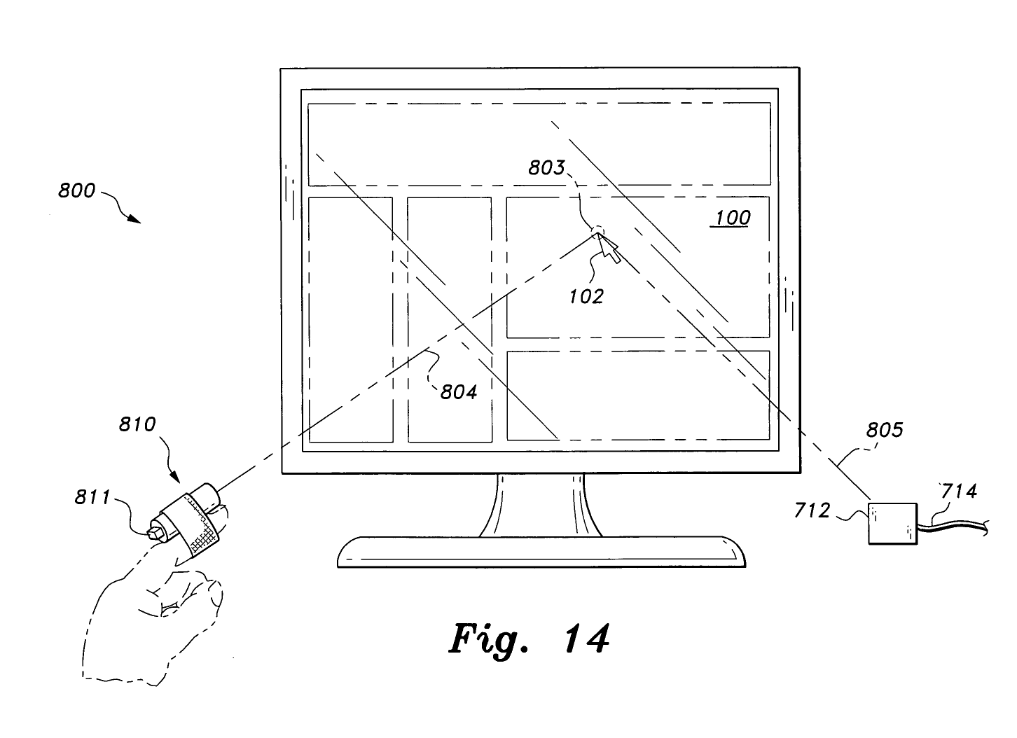

As shown in FIG. 14, the directional light source 810 may, alternatively, be adapted for mounting to the user's hand or fingers. In system 800, light beam 804 is generated in a manner similar to that described above with reference to FIG. 12, but the directional light source 810 is attached to the user's finger rather than being mounted on a separate surface, such as toy gun TG. Light source 810 generates an impingement point 803, as described above, which is read by the camera 712 (along directional path 805). Such mounting to the user's hand would allow for mouse-type control movement, but without requiring the user to use a mouse. Three-dimensional designs could also be created by the user via movement of the user's hand in three-dimensional space.

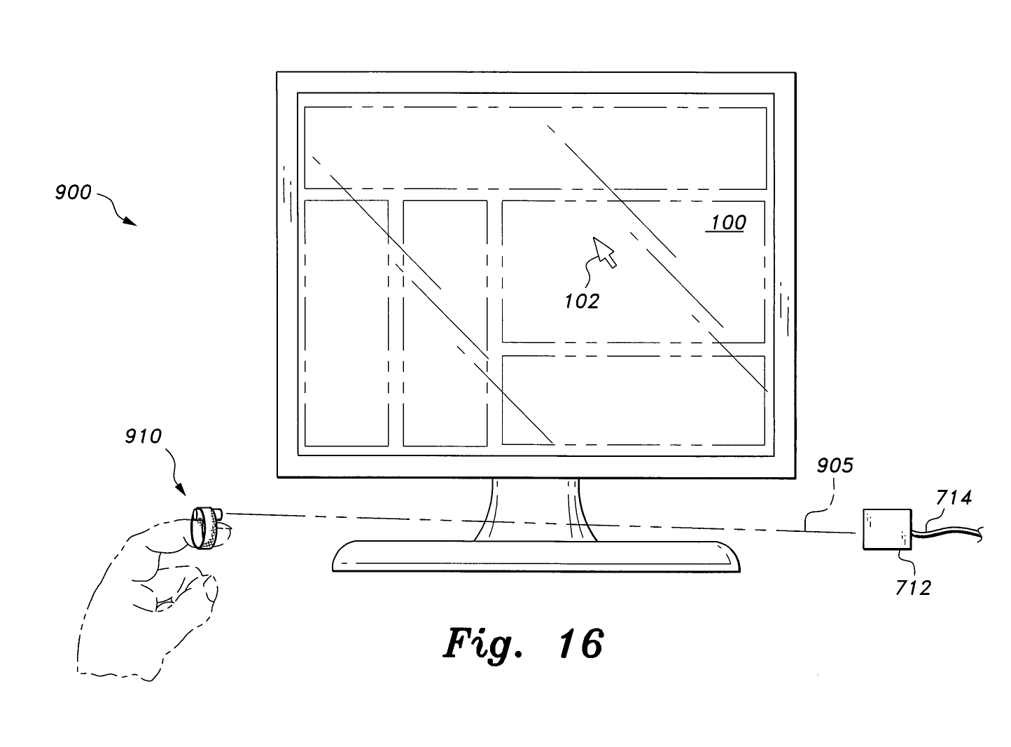

As a further alternative, as shown in system 900 of FIG. 16, an infrared source, such as the laser described above, infrared light emitting diodes (LEDs) or the like, may be worn on the user's fingers or hands, but the produced beam does not need to be pointed directly at the screen. Instead, the camera 712 is pointed at the user's finger(s) and detects movement of the “dot” or light beam source. In FIG. 16, a single infrared LED lighting unit 910 is shown attached to one of the user's fingers, although it should be understood that multiple light sources may be attached to multiple fingers, thus allowing camera 712 to track multiple light sources. Similarly, it should be understood in the previous embodiments that multiple light sources may be utilized to produce multiple impingement spots.

In use, the pinhole camera 712, as described above, would be calibrated by the user positioning his or her finger(s) at a selected spot in the air (away from the monitor 100), which would be read by the camera 712 and chosen to correspond to the Cartesian coordinates of (0,0), corresponding to the upper, left-hand corner of the display screen. The camera 712 may then track the movement of the user's finger(s) via the light source 910 to control cursor movement without requiring the direct, line-of-sight control movement described above. This embodiment may be used to control the movement of the cursor 102 itself, or may be coupled with the cursor control systems described above to add additional functional capability, such as a control command to virtually grasp an object displayed on the monitor.

The camera 712 may be mounted directly to the monitor or positioned away from the monitor, as shown, depending upon the user's preference. The signal produced by LED 910 may be tracked using any of the methods described herein with regard to the other embodiments, or may, alternatively, use any suitable light tracking method.

In the embodiment of FIG. 13, the user may mount the light source 710 directly to the toy gun TG, which the user wishes to use as a video game controller or the like. In the United States, gun-shaped video game controllers must be colored bright orange, in order to distinguish the controllers from real guns. Users may find this aesthetically displeasing. System 700 allows the user to adapt a realistic toy gun TG into a visually appealing video game controller. Further, it should be noted that system 700 allows for generation of a true line-of-sight control system. The preferred laser pointer preferably includes a laser diode source and up to five control buttons, depending upon the application. The laser diode is, preferably, a 5 mW output laser diode, although safe ranges up to approximately 30 mW may be used. The laser preferably includes a collimating lens for focusing the beam into the impingement spot.

In FIG. 14, a motion sensor 811 has been added to the light source. The motion sensor 811 may be a mechanical motion sensor, a virtual motion sensor, a gyroscopic sensor or the like. This alternative allows movement of the device or the user's hand to activate computer function control signals, such as mouse-click signals. Further, it should be understood that the tracking and control systems and methods described above may be used for other directional control, such as movement of game characters through a virtual environment or game.

The computer system in the above embodiments may be a conventional personal computer or a stand-alone video game terminal. The computer is adapted for running machine vision software, allowing the set of coordinates generated by sensor 712 to be converted into control signals for controlling movement of the cursor 102. Horizontal and vertical (x and y Cartesian coordinates, preferably) pixel coordinates are read by sensor 712, and the x and y values may be adjusted by “offset values” or correction factors generated by the software, and determined by prior calibration. Further correction factors may be generated, taking into account the positioning of the sensor 712 with respect to the display 100. The software for converting the location of the impingement point 703, 803 (read by camera 712 along path 705, 805) is run on the computer connected to camera 712 by cable 714. Alternatively, a processor mounted in camera 712 may convert the location of the impingement point 703 from camera image pixel location coordinates to computer display location coordinates, which are sent to the computer by cable or wireless signal. Software running on the computer then relocates the computer display location indicator, such as a cursor, to the impingement point 703. The software allows for calibration of the x and y values based upon the display's dimensions, and also upon the position of the camera 712 relative to the display 100. The camera 712, utilizing the software, may read either direct display pixel values, or convert the pixel values into a separate machine-readable coordinate system.

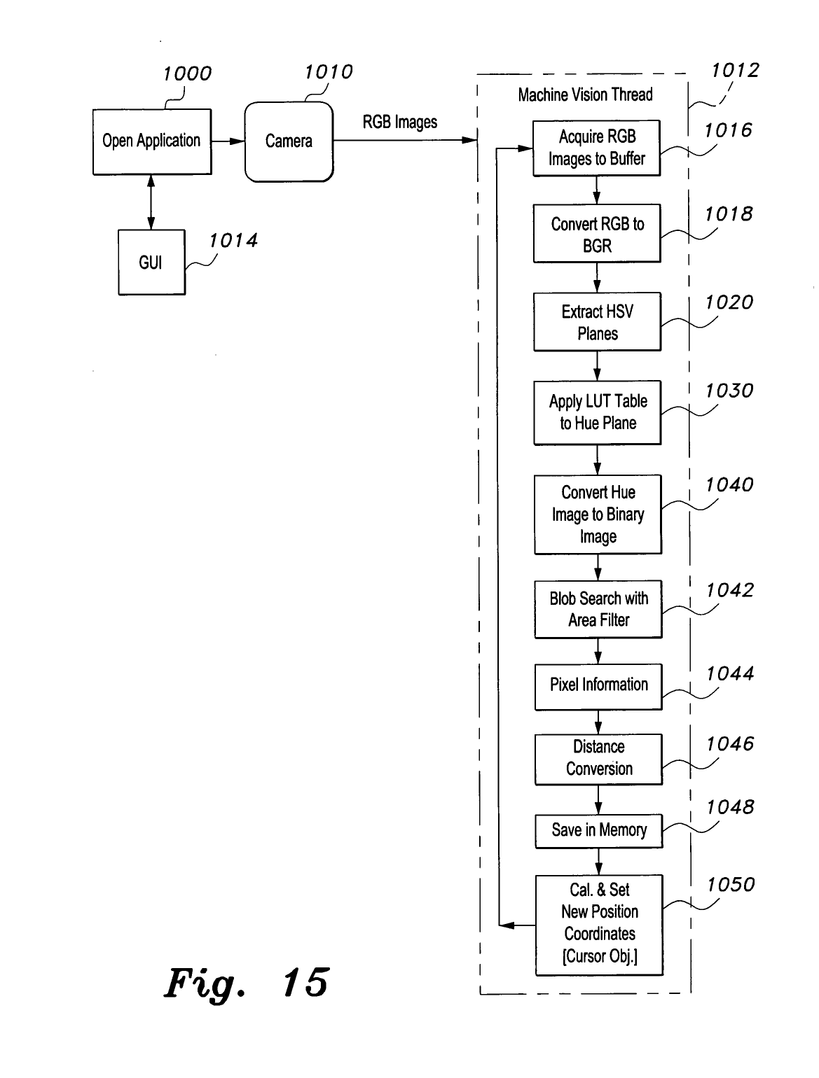

In the alternative embodiment of FIG. 15, a handheld camera, as described above in the embodiments of FIGS. 1-11, may be used, with the camera being any suitable camera, either adapted for grasping in the user's hand or mounting on a controller, as described above. The camera is connected to the computer through either a wired or wireless interface, and a graphical user interface having a cursor (such as cursor 102) presents a display on monitor 100. The camera is pointed towards display 100 to calibrate the system. The camera takes a digital image of the display for a predetermined period of time, such as fifteen milliseconds. The camera takes an image of the cursor 102 and the surrounding display in order to determine the position of the cursor 102 on the screen.

As shown in FIG. 15, the initiation of the program begins at step 1000. The application is opened, and the graphical user interface 1014 generates a display. Camera 1010 takes images of the display, which are communicated to the computer either by cable or wireless connection. Following calibration, cursor 102 is converted from a typical white display to a red display. The Machine Vision Thread 1012 is then launched on the computer, which retrieves red, green and blue (RGB) pixel color information picked up by camera 1010, and this information is buffered at step 1016.

The RGB information is then converted to blue-green-red (BGR) information (i.e., the red information is transformed into blue information, etc.) at step 1018. The image is then divided into separate hue, saturation and value (HSV) planes at step 1020. A software filter with a lookup table (LUT) zeros all pixel information in the hue image that is not blue, thereby isolating the information that was initially red information in the original RGB image (step 1030). Following this, the filtered image (red information only) is converted to a binary image at step 1040.

The Machine Vision Thread 1012 then searches for a “blob” shape, i.e., a shape within a given size region, such as greater than fifty pixels in area, but smaller than 3,500 pixels. The filtered blobs are then filtered again by color testing regional swatches that are unique to the cursor object, thus eliminating false-positive finds of the cursor object (step 1042).

If the cursor 102 is found, the pixel distance within the image from a pre-selected region (referred to as a “swatch”) on the mouse cursor object to the center of the image is calculated (step 1044). Next, the distance is converted to monitor pixel distance with an offset calculated for distortions due to the camera viewing angle of the mouse cursor object (step 1046). Then, at step 1048, the area of the found blob is saved in memory for later analysis for gesturing.

If the cursor image cannot be found, a “miss” is recorded in memory for later analysis and self-calibration. At step 1050, the open Machine Vision Thread 1012 from the GUI 1014 calls a specific function, setting the mouse cursor object screen coordinates to the newly calculated coordinates, which place the cursor on the screen in the center of the field of view of the camera 1010. The process is then repeated for the next movement of the cursor (and/or the camera).

Further, a stopwatch interrupt routine may be added for analyzing the change in mouse cursor pixel area per time unit (saved in step 1048), and if a certain predetermined threshold is reached, a mouse click, double click, drag or other controller command will be executed. The stopwatch interrupt routine may further analyze the change in “hit rate”, and if a lower threshold is reached, a self-calibration routine is executed, resulting in a change of the exposure time or sensitivity of the camera via the camera interface in order to address low light conditions.

In some embodiments, a mechanical filter may be positioned on the camera for filtering the red image, rather than employing a digital or software filter. Similarly, rather than employing BGR at step 1018, a BGR camera may be provided.

It is to be understood that the present invention is not limited to the embodiments described above, but encompasses any and all embodiments within the scope of the following claims.

I claim:

1. A method of making a cursor image on a computer display track a line of sight of a computer pointing device, comprising the steps of:
aiming the computer pointing device at the cursor image;
recording a digital image of the computer display along the line of sight of the computer pointing device, the digital image defining a field of view of the computer pointing device, the field of view having a center;
determining whether the cursor image has been found within the recorded digital image;
obtaining first color, second color and third color sets of information from the cursor image when the cursor image has been found within the recorded digital image;
transposing the first set of color information with the third set of color information;
filtering the cursor image to obtain an image formed from only the transposed first set of color information;
calculating a distance from a predetermined region of the filtered cursor image to the center of the field of view;
moving the cursor image from coordinates of the predetermined region of the filtered cursor image to the center of the field of view; and
repeating all of the above steps at millisecond time intervals in order to make the cursor image track the line of sight of the computer pointing device.

2. The method of making a cursor image on a computer display track a line of sight of a computer pointing device as recited in claim 1, wherein said step of obtaining first color, second color and third color sets of information from the cursor image includes obtaining red information for said first set of color information, obtaining green information for said second set of color information, and obtaining blue information for said third set of color information.

3. The method of making a cursor image on a computer display track a line of sight of a computer pointing device as recited in claim 2, further comprising the step of extracting hue, saturation and value planes from the first color, second color and third color sets of information.

4. The method of making a cursor image on a computer display track a line of sight of a computer pointing device as recited in claim 3, further comprising the step of applying a lookup table to the extracted hue plane.

5. The method of making a cursor image on a computer display track a line of sight of a computer pointing device as recited in claim 4, further comprising the step of converting a hue image of the hue plane to a binary cursor image.

6. The method of making a cursor image on a computer display track a line of sight of a computer pointing device as recited in claim 5, further comprising the step of storing the position of the cursor image in computer memory when the cursor image is aligned with the center of the field of view of the computer pointing device.

7. A system for virtually determining cursor commands, comprising:
a computer processor;
a cursor command unit in communication with the computer processor;
means for emitting a plurality of signals from the cursor command unit;
means for determining changes in distance from a first position of the cursor command unit to a second position of the cursor command unit in relation to a computer display and determining time intervals between the first position and second position; and
means for directing the processor to execute a specific cursor command based on changes in distance and the time intervals.

8. A method of virtually determining cursor commands using the system of claim 7, comprising the steps of:
emitting a signal from a cursor command unit;
determining changes in distance from a first position of the cursor command unit to a second position of the unit in relation to a computer display;
determining time intervals between the first position and the second position;
based on the changes in distance and the time intervals, directing the processor to execute a specific cursor command.

9. The method of virtually determining cursor commands using the system as recited in claim 8, wherein said step of determining time intervals between the first position and the second position includes detection of changes in size of at least one projected light spot.

10. A computer input pointing device, comprising:
a directional light source for generating a directional light beam in a predetermined frequency spectrum, the directional light source being adapted for producing at least one impingement point on a computer display at a desired location;
an optical sensor for tracking the at least one impingement point and generating a signal corresponding to the location of the impingement point on the computer display, the optical sensor having a filter for filtering light outside of the predetermined frequency spectrum of the directional light source, the optical sensor being pointed at the computer display for tracking the at least one impingement point on the computer display;
means for communicating the signal generated by the optical sensor to a computer generating an image on the computer display; and
means for changing location of an indicator on the computer display in response to the signal generated by the optical sensor in order to relocate the indicator at the location of the at least one impingement point.

11. The computer input pointing device as recited in claim 10, further comprising means for releasably securing said directional light source to a mobile support surface.

12. The computer input pointing device as recited in claim 11, further comprising an auxiliary control device having a user interface and being adapted for mounting to the mobile support surface, the auxiliary control device being in communication with the computer and selectively generating control signals for the computer.

13. The computer input pointing device as recited in claim 10, wherein the predetermined frequency spectrum of the directional light beam is selected from the group consisting of the infrared spectrum and the near infrared spectrum.

14. The computer input pointing device as recited in claim 10, wherein the directional light source comprises a laser pointer.

15. The computer input pointing device as recited in claim 10, wherein the optical sensor is a digital camera having filters limiting received images to the infrared or near infrared spectrum.

16. The computer input pointing device as recited in claim 10, wherein the at least one impingement point includes a modulated signal for computer function control.

17. The computer input pointing device as recited in claim 10, further comprising at least one motion sensor for generating computer function control signals.
